(19) United States
(12) Patent Application Publication
(10) Pub. No.: US 2023/0101238 A1
(43) Pub. Date: Mar. 30, 2023

(54) Foldable Screen Shade for a Display Device

(71) Applicant: Mary Ellison, Lapeer, MI (US)

(72) Inventor: Mary Ellison, Lapeer, MI (US)

(21) Appl. No.: 17/547,978

(22) Filed: Dec. 10, 2021

Related U.S. Application Data
(60) Provisional application No. 63/247,842, filed on Sep. 24, 2021.

(51) Int. Cl. G06F 1/16; H04N 5/64

(52) U.S. Cl. CPC G06F 1/1603; G06F 1/1616; G06F 1/1609; H04N 5/64

(57) ABSTRACT

The present invention relates to a lightweight, cost-effective and foldable screen shield for use with a portable electronic device. The shield has a back portion that is secured to the back of the screen, a top portion that lies horizontally above the screen to protect the screen from light and a pair of side panels covering the screen from side edges. The side panels and the top portion are collapsible, and can be secured with a pair of elastic straps or other fastener. The elastic straps are used for securing the shield device to the bezel or frame in an unfolded orientation, thereby allowing a secure attachment. The top section can be expanded and two side panels are pulled outward from the longitudinal edges. The top section and side panels form a three-sided barrier around the screen to block glare.

### CROSS-REFERENCE TO RELATED APPLICATION

The present application claims priority to, and the benefit of, U.S. Provisional Application No. 63/247,842, which was filed on Sep. 24, 2021 and is incorporated herein by reference in its entirety.

### FIELD OF THE INVENTION

The present invention relates generally to the field of shade and protection devices for electronics. More specifically, the present invention relates to a foldable screen shade device for use with laptops, tablets and other portable electronics. The shade device is designed for shielding a computer or tablet screen against excess light and glare. The invention shields the screen from three sides using a hood on the top of the screen and a pair of side panels. The device is a one-piece unit and contacts the back side of the screen. The shade can accommodate laptops and tablets of various sizes, and can be unfolded to secure to the screen. Accordingly, the present disclosure makes specific reference thereto. Nonetheless, it is to be appreciated that aspects of the present invention are also equally applicable to other like applications, devices and methods of manufacture.

### BACKGROUND

By way of background, portable computing devices and especially laptops, tablets, notebook computers and other portable electronics such as a smart phones, game systems and the like have a display screen for displaying data, images, text, documents, graphics and the like to the user. By their nature, laptops, tablets and notebook computers are intended to be functional when used outdoors. However, it is well-known that under some circumstances ambient sunlight can make display screens on these devices difficult to view, due to the glare caused by the sunlight. These tablet computers are often used in bright environments that make the displays difficult to see. Bright light or sunlight is a challenge to users of tablet and laptop computers, as the screen of the cell phone, portable electronic or tablet computer is usually not bright enough to be seen when the sun is shining brightly.

Usually, people use one or more of their hands to cup around the edges of the display or hold up a paper or magazine to reduce the light and glare of the screen. This is not only ineffective, but is also discomforting and potentially embarrassing for a user. Further, work efficiency is also reduced for the user as the individual cannot use both hands to operate the keyboard or device. Alternatively, users try to increase the brightness of their computer, but this does not always work when working on beaches or in bright sunlight, and it also causes the battery of the computer to rapidly drain.

Shading devices for laptops, other portable electronics and notebook computer screens are usually not readily available, as they are bulky, non-foldable and expensive. Devices which are permanently affixed can unduly add to the size, weight, cost, or complexity of the computing device. People carry them, but rarely use them, as they are generally difficult to install and are ineffective and are often forgotten when the person goes outside, as it is another accessory they have to take.

Therefore, there exists a long felt need in the art for a computer or portable electronic screen-shielding device that shields the screen from excess light and glare. There is also a long felt need in the art for a screen shade that enables users to clearly view the screen, even in high light situations. Additionally, there is a long felt need in the art for a computer screen-shielding device that can be used both indoors and outdoors. Moreover, there is a long felt need in the art for a display screen device that eliminates the need for users to use their hands around the edges of the screen for preventing glare. Further, there is a long felt need in the art for a screen shield device that is lightweight, cost-effective and portable. Furthermore, there is a long felt need in the art for a tablet computer screen shade device that can be easily mounted and removed from the screen. Finally, there is a long felt need in the art for a screen shade device that is inexpensive to manufacture, foldable and can cover the screen to protect against excess light and glare with minimal effort.

The subject matter disclosed and claimed herein, in one embodiment thereof, comprises a foldable shade for a notebook computer screen. The foldable shade features a back portion with a length substantially equal to the screen and width longer than the screen, a hood top pivotally attached to the back portion and having a width less than the back portion, two side panels extending from the longitudinal edges of the hood top. Each side panel has a curved edge and a free edge, and each of the free edges has a tab configured to lock into slots positioned on the back portion for securing the shade around the screen of the electronic device. A pair of elastic straps secure the shade to the bezel of the screen, and an upper strap secures to top bezel portion and a lower strap secures to bottom bezel portion of the screen. When the shade is installed, the side panels extend perpendicularly from the longitudinal edges of the hood top, and the hood top lies horizontally above the screen.

In this manner, the novel foldable screen shade of the present invention accomplishes all of the forgoing objectives and provides a relatively cost-effective, lightweight and effective solution for people to clearly view the screen of their notebook computer or other electronic device in bright or ambient light. The shade device is foldable and can be selectively expanded to shield against bright light, thereby enabling the individual to better see the screen. Further, the shade device can accommodate portable electronic devices, laptops and notebook computers of various sizes, and can be used in both indoor and outdoor environments.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a foldable shade for notebook computers and other portable electronic screens. The foldable shade is designed for shielding the screen of a laptop, tablet, portable electronic device, or notebook computer from glare and ambient light, and provides protection from the top and sides of the screen. The foldable shade further includes a back portion with a length substantially equal to the screen and width longer or greater than the screen. A hood top is pivotally attached to the back portion and has a width that is shorter than the back portion. Two side panels extend from the longitudinal edges of the hood top, with each side panel having a curved edge and a free edge. The free edge has a tab that is configured to lock into slots or grooves positioned on the back portion for securing the shade around the screen. A pair of elastic straps or other fasteners are provided for securing the shade to the bezel of the screen. The upper strap or fastener secures to the top bezel portion and a lower strap or fastener secures to the bottom bezel portion of the screen. When the shade is installed, the side panels extend perpendicularly from the longitudinal edges of the hood top, and the hood top lies horizontally above the screen.

In yet another embodiment of the present invention, a pair of relief notches are disposed at the ends of a common edge between the hood top and the back portion for pivotal movement of the hood top relative to the back portion. The common edge can also have a hinge or fold line to facilitate folding of the screen.

In yet another embodiment, the shade device is made from one or more of PVC, cardboard, plastic, paperboard, recycled plastic or other post-consumer waste materials, coated stock to make the screen impervious to rain or moisture, hard paper or combinations thereof. The invention can also be provided with various graphics, text, other indicia and designs so that it can serve as a promotional device or may otherwise be personalized.

In yet another embodiment, the foldable shade device can be folded when not used for providing shade or shielding of the screen, and can be secured using the elastic upper strap and the lower strap or other fasteners such as hook and loop fasteners.

In yet another embodiment of the present invention, a folding notebook computer shade for shielding a laptop screen or the display of other portable electronic devices from three sides is disclosed. The folding notebook computer shade or hood shields the screen from the top of the screen and sides of the screen to prevent light from impinging onto the screen and obscuring the display. The folding notebook computer hood also includes a back portion and a pair of straps or fasteners that secure the hood or shade to the screen or screen support. A hood top portion lies flat and extends horizontally over the top of the screen and a portion of the keyboard to prevent light from the top of the screen. The shade includes a right-side panel that extends perpendicularly from a first edge of the hood or shade top portion to prevent light from entering from one side of the screen, and a left side panel extending perpendicularly from a second edge of the hood top portion to prevent light from entering from the other side of the screen. The side panels are secured to the back portion through a pair of tabs that are fastened to the slots or grooves positioned on the back portion. Alternatively, the side panels can be held in position by other fasteners.

In yet another embodiment of the present invention, a method for shielding or otherwise protecting a notebook computer screen from ambient light and glare is disclosed. The method includes the steps of securing a screen shielding or shading device to the back portion of the screen or support for a screen using a pair of elastic straps or other fasteners, then, positioning a back portion or cover of a shielding or shading device along the back of the screen, such that a pair of slots or grooves positioned on the back portion lie beside or are adjacent to the side edges of the screen, thereafter lifting a top hood portion from a first position where the top hood portion may be secured to the back portion, to a second position vertically above the screen. Then, a user unfolds a pair of side panels which are attached to longitudinal edges of the hood top portion and the side panels are perpendicularly placed to the top hood portion when unfolded. Finally, the side panels are pulled down, such that the top portion becomes horizontally disposed and a tab present on each side panel secures to a slot positioned on the back portion, thereby allowing the side panels to be fixed in position and prevent light from falling onto the screen from the sides of the screen.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a foldable screen shade for a display device of the present invention in an unfolded position in accordance with the disclosed architecture;

FIG. 2 illustrates a perspective view of one potential embodiment of a foldable screen shade for a display device of the present invention in a folded position in accordance with the disclosed architecture;

FIG. 3 illustrates a planar view of one potential embodiment of a foldable screen shade for a display device of the present invention in an unfolded orientation with the side panels extending outwardly from the top hood in accordance with the disclosed architecture;

FIG. 4 illustrates a perspective view of a laptop with one potential embodiment of a foldable screen shade for a display device of the present invention installed thereon for protection of the screen against ambient light and glare in accordance with the disclosed architecture;

FIG. 5 illustrates a perspective view of the process of unfolding one potential embodiment of a foldable screen shade for a display device of the present invention for installation on a computer screen in accordance with the disclosed architecture; and

FIGS. 6A, 6B, 6C and 6D illustrate exemplary steps for unfolding one potential embodiment of the foldable screen shade for a display device of the present invention while the screen shade is secured to a laptop screen using fasteners in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a computer screen shielding or shading device that shields or shades the screen from excess light and glare, as well as from moisture or other debris such as leaves or other organic matter falling on the electronic device. There is also a long felt need in the art for a screen or display shade that enables users to clearly view the screen or display. Additionally, there is a long felt need in the art for a computer screen or display for shielding or shading that can be used in both indoors and outdoors. Moreover, there is a long felt need in the art for a display screen hood that eliminates the need for users to use their hands or other impromptu shading devices around the edges of the screen for preventing glare. Further, there is a long felt need in the art for a screen shield device that is lightweight, cost-effective and portable. Furthermore, there is a long felt need in the art for a tablet computer screen shade that can be easily mounted and removed from the screen or display. Finally, there is a long felt need in the art for a screen shade that is foldable, highly portable and can cover the screen to protect against excess light and glare with minimal effort.

The present invention, in one exemplary embodiment, is a novel method for shielding a notebook computer screen from ambient light and glare. The method includes the steps of securing a screen-shielding device to the back portion of the screen using a pair of elastic straps or other fasteners, then positioning a back portion or cover of a shielding or shading device along the back of the screen such that a pair of slots or grooves positioned on the back portion lies besides or is adjacent to the side edges of the screen. Next, the top hood portion is lifted from a first position where the top hood portion contacts to the back portion to a second position vertically above the screen. Then, a user unfolds a pair of side panels such that the side panels are attached to the longitudinal edges of the hood top portion, and the side panels are perpendicularly placed to the top hood portion when unfolded. Finally, the side panels are pulled down, such that the top portion is disposed horizontally and a tab present on each side panel secures to a slot or grooves positioned on the back portion, thereby allowing the side panels to be secured and preventing light from falling onto the screen from the sides of the screen.

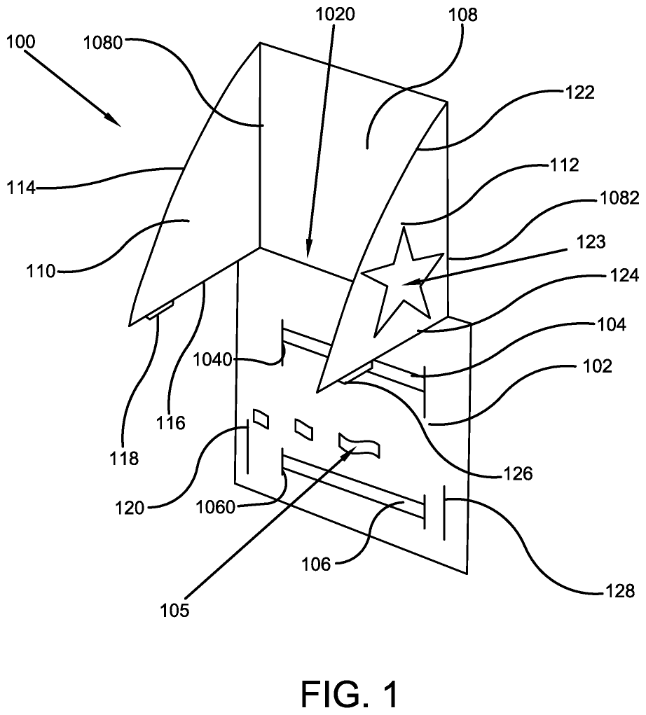

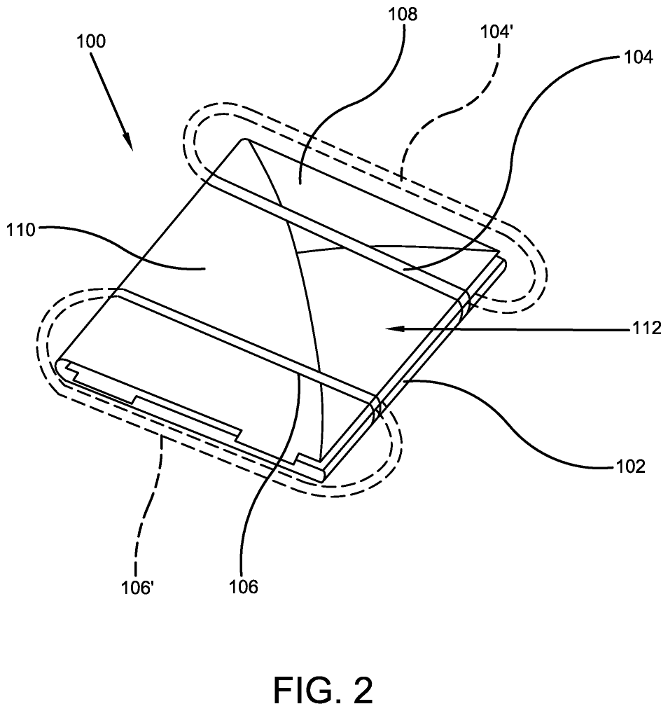

Referring initially to the drawings, FIG. 1 illustrates a perspective view of a foldable screen shade or shield of the present invention in an unfolded position in accordance with the disclosed specification. The shade or screen device 100 of the present invention is designed as a unique electronic device, such as a laptop or notebook computer hood that prevents glare and other light from interfering with the view of the screen. The device 100 is preferably made from is made from material such as, but not limited to: PVC, cardboard, plastic, paperboard, recycled plastic or other post-consumer waste materials, coated stock to make the screen impervious to rain or moisture, hard paper or combinations thereof. The device 100 can be sized and configured to fit on any portable electronic device, including laptops, games, cell phones and other items that have a display. More specifically, the shield device 100 has a back portion 102 that contacts the rear side of the screen of the electronic device. The back portion 102 has a pair of elastic circular straps or other fasteners, including an upper strap 104 and a lower strap 106 or first and second fasteners. The fasteners can be provided in continuous strips, or discontinuous spots or combinations of continuous and discontinuous elements 105. Both the straps or fasteners 104, 106 may be circular, elastic, flexible, made of a fabric material, and are used to secure the shade 100 in a folded position. The upper strap 104 and the lower strap 106 pass through the back portion via an upper strap opening 1040 and a lower strap opening 1060. The upper strap 104 can be adjusted vertically to the screen size 402 of a laptop 400. In addition, both straps 104, 106 can be used to secure the hood top 108 in a closed position when not in use. The hood top 108 is configured to cover the screen from the top, and pivotally moves along the edge 1020 of the back portion 102. The hood top 108 pivotally moves between a first position that is perpendicular to the back portion 102 when the shade device 100 is in the unfolded position, and a second position wherein the hood top 108 contacts the back portion 102 when the shade device 100 is in a folded position as shown in FIG. 2.

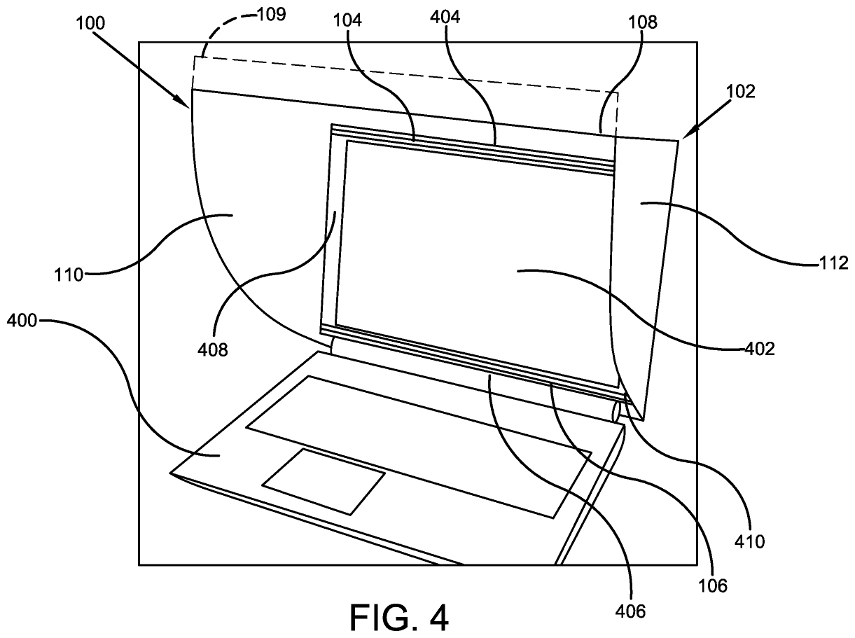

A right-side panel 110 extends outwardly along the right edge 1080 of the shade top 108, and a left side panel 112 extends along the left edge 1082. The top 108 may have an extension flap 109 (see FIG. 4) which can be folded upwardly from the top to provide a further block to light coming on from the front of the electronic device. The extension flap 109 may also have a size similar to the size of the top 108 so that it can form a sun blind for the user. The side panels 110, 112 are configured to pivotally rotate along the edges 1080, 1082 respectively, such that in the unfolded position, the side panels 110, 112 are perpendicular to the hood or shade top 108. Thus, when the hood or shade top 108 is positioned flat over the top bezel, frame or support of a screen as shown in FIG. 4, the side panels 110, 112 extend perpendicularly downward from the edges 1080, 1082 to cover or protect the screen on both sides. Each of the side panels 110, 112 has a curved edge for providing adequate protection from glare and sunlight, such that the curvilinear shape does not interfere with the use of the keyboard, and a free edge that attaches to the back portion 102 using a tab that is inserted into a slot or groove of the back portion 102. As shown, the right-side panel 110 has the curved edge 114 and a free edge 116 having a tab 118. For securing the right-side panel 110, the tab 118 is inserted into a slot or groove 120 positioned on the back portion 102. Similarly, the left side panel 112 has the curved edge 122 and a free edge 124 that has a tab 126. For securing the left side panel 112, the tab 124 is inserted into a slot or groove 128 that is positioned on the back portion 102 to receive the tab 124. The curved edges 122 and 114 are spaced from the keyboard so that the curved edges do not interfere with the keyboard.

The hood or shade top 108 and the back portion 102 can be coupled using a hinge or fold line (not shown) that allows pivotal movement of the hood or shade top 108 along the edge 1020. It should be appreciated that the hood or shade top 108 and the side panels 110, 112 form a three-sided barrier around a screen to block substantially all the glare and maintain clear viewing of the screen for a user. The straps or fasteners 104, 106 are used for securing the back portion 102 to the back of the laptop or notebook computer and can secure to the bezel or supporting frame so that view of the screen is not obstructed for user. The top and side panels may have graphics, indica, text or other collateral 123 so that the user can personalize the shade or shield. The graphics 123 can be part of marketing collateral, such that the shade or screen can be given away as part of a promotional offering. In alternative embodiments, the side panels 110 and 112 may also be made from a light-filtering material which will block most of the light reaching the screen or display, but not all of the light, in the event some illumination is needed.

In the preferred embodiment, the width of the back portion 102 is slightly greater than the width of the hood or shade top 108, such that the back portion 102 prevents the light from passing from the sides of the screen, and also the straps 104, 106 can easily hold the hood or shade top 102 with folded side panels in the folded position.

FIG. 2 illustrates a perspective view of a foldable screen shade or shield device of the present invention in a folded position in accordance with the disclosed structure. In the folded position, the back portion 102 and the hood top 108 contact each other. The side panels 110, 112 are folded towards the top 108, and contact the hood top 108 such that one of the side panels partially overlaps the other side panel. As shown, the left side panel 112 is partially overlapped by the right-side panel 110. Then, for securing the hood 100 in the folded position, the elastic straps 104, 106 are used that secure the back portion 102, the hood top 108 and the side panel 110,112 securely.

For unfolding the hood device 100 and securing to a screen, the upper strap or fastener 104 is removed by pulling to bring it into position 104. The upper strap or fastener 104 is secured to the top area of the bezel or support frame of a screen or shield as illustrated in FIG. 4. Similarly, the lower strap or fastener 106 is removed by pulling to bring the shield into position 106. The lower strap or fastener 106 is secured to the bottom area of the bezel or support frame of the screen. It should be noted that the straps or fasteners 104, 106 are flexible and elastic, and once brought in positions 104, 106, then the side panels 110, 112 can be pulled and extended sidewards from the top 108 to cover the screen from three sides for protection against light and glare.

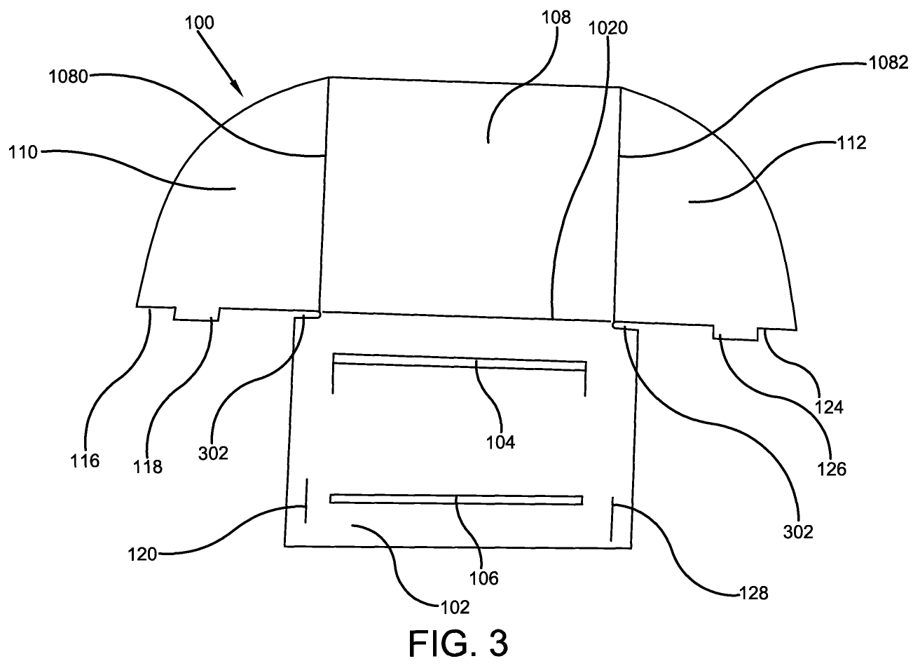

FIG. 3 illustrates a planar view of the hood device 100 in an unfolded orientation with the side panels extending outwardly from the top hood or shield in accordance with the disclosed structure. As shown, the back portion 102 is slightly larger in width than the hood top 108. The width of the back portion 102 is enough to contact and completely cover the back of a laptop or notebook computer or other electronic device having a display, to which the hood or shield device 100 is secured. For allowing pivotal movement of the top 108 relative to the back portion 102, a pair of relief notches 302 are positioned at the ends of the edge 1020. The relief notches 302 allow the side panels 110, 112 to be pulled easily outward, and the pivotal movement of the hood top 108 is facilitated by the notches or other fold assists.

The slots or grooves 120, 128 are positioned on the back portion 102 such that they align with the edges 1080, 1082 of the hood top 108. When the side panels 110, 112 are positioned perpendicularly to the hood top 108, the tabs 118, 126 are secured to the slots or grooves 120, 128 respectively. This allows the side panels 110, 112 to protect the screen on the sides while the hood top 108 protects the glare on the screen from the top. The upper strap 104 also has a band to adjust the hood device 100 to the different notebook or other device sizes. It should be noted that the pair of side panels 110, 112 are symmetrical, and the length of the free edges 116, 124 is substantially similar to the length of the back portion 102 such that the side panels 110, 112 completely cover the screen from both of the sides.

FIG. 4 illustrates a perspective view of a laptop with screen shade device 100 of the present invention installed for protection of the screen against ambient light and glare in accordance with the disclosed structure. As stated earlier, the shade or shield device 100 of the present invention provides protection of the screen 402 of a laptop 400 against the glare and ambient light from three sides. More specifically, in the installed and unfolded orientation, the hood top 102 covers the screen 402 from the top while the side panels 110, 112 cover the screen from sides 408, 410 respectively. The folding notebook computer hood 100 is a one-piece unit, and the back portion 102 contacts or is otherwise secured to the back of the laptop 400. During installation, the straps or fasteners of the hood 100 are attached to the bezel or support frame of the screen 402.

As shown, the upper strap or fastener 104 is secured to the top bezel or frame portion 404 and the lower strap or fastener 106 is secured to the lower bezel or frame portion 406 for securing the shade or shield device 100 to the electronic item. The right-side panel or wing 110 is positioned along the side edge 408 and the tab 118 (shown in FIG. 1 and FIG. 3) is secured to the slot or groove 120 (FIG. 1). Similarly, the left side panel 112 is positioned along the side edge 410 and the tab 126 is secured to the slot or groove 128. FIG. 4 also shows an extendable flap portion 109 which may be folded up or down from the plane in which the hood top 108 lies so that the flap can be used to help shield the eyes of the user from the oncoming light.

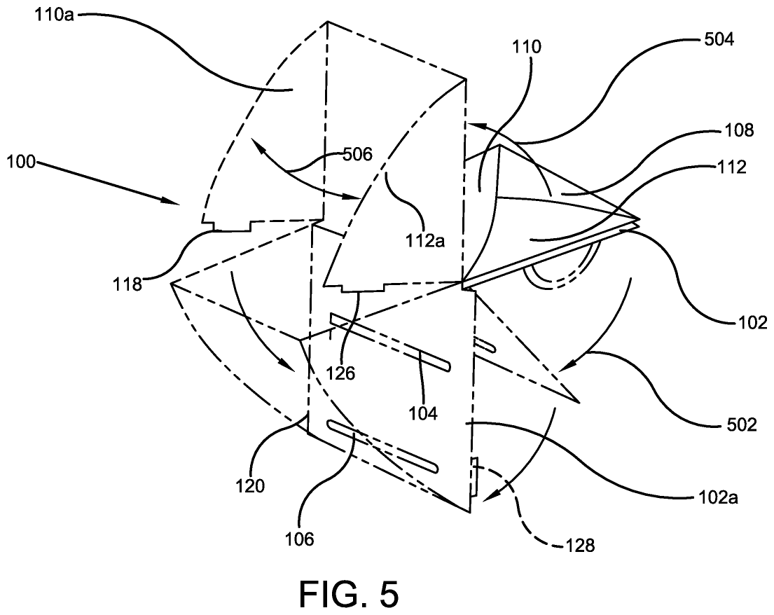

FIG. 5 illustrates a perspective view showing the process of unfolding the foldable computer screen hood 100 for installation on a computer screen or display in accordance with the disclosed specification. For installation and unfolding, the upper strap or fastener 104 and the lower strap or fastener 106 are pulled as shown in FIG. 2 to release the hood top 102 and the side panels 110, 112. The upper strap or fastener 104 is secured to the upper bezel or frame portion and the lower strap or fastener 106 is secured to the lower bezel or frame portion of the screen as shown in FIG. 4.

Then, the back portion 102 is pulled down in the direction 502 so that the back portion 102 can contact or be otherwise fastened to the back of the screen or display, and reach position 102a. Thereafter, the hood top 108 is pivotally pulled up in the direction 504 to reach the position 108a. Once the hood top 108 is substantially aligned or coplanar with the back portion 102, then the side panels 110, 112 are opened (pulled apart as shown in the direction 506) to become perpendicular to the hood top 108 as shown in the position 110a, 112a. Thereafter, the side panels 110, 112 are pulled down from the position 110a, 112a, such that the tabs 118, 126 are secured to the slots 120, 128 respectively, to shield the screen or display as shown in FIG. 4. It should be noted that the back portion 102, when contacting or being secured to the back of the laptop screen, the slots 120, 128 are positioned besides the screen or display such that the tabs 118, 126 are easily secured to the slots 120, 128.

For folding the hood 100, the aforementioned steps are performed in reverse, where the tabs 118, 126 are removed from the slots 120, 128 followed by collapsing the side panels 110, 112 to contact or be secured to the hood top. Then, the hood top 108 and the back portion 102 contact or are secured to each other and the straps 104, 106 secure the hood 100 as shown in FIG. 2.

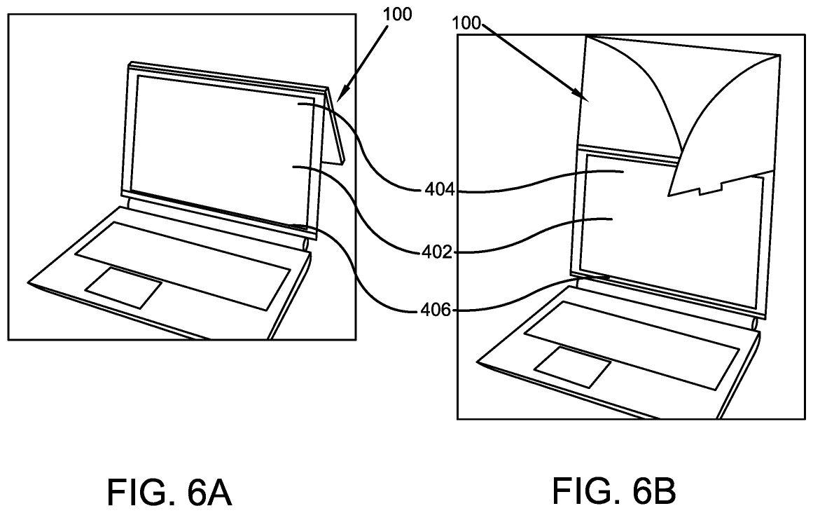

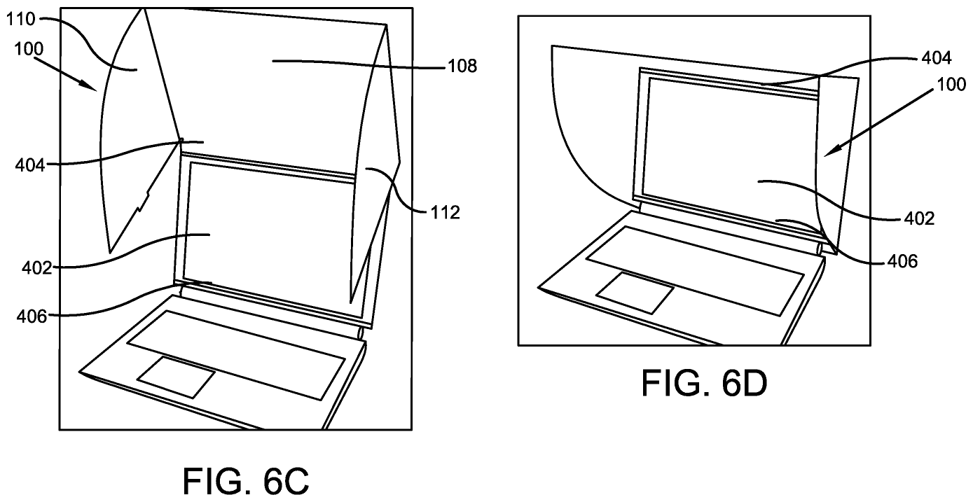

FIGS. 6A, 6B, 6C and 6D illustrate exemplary steps for unfolding the invention 100 when the shield or shade 100 is secured to the screen using the straps or fasteners 104, 106 in accordance with the disclosed specification. It should be noted that the steps embodied in FIGS. 6A, 6B, 6C and 6D are similar to the steps described in FIG. 5, and any additional steps may be added or the order of the steps can be varied as per the preferences of the user.

Initially, as shown in FIG. 6A, the shade or shield 100 is secured to the screen or display 402 using the straps 104, 106 attached to the bezel or frame area 404, 406. The hood top 108 is lifted or pulled up slightly to bring it to the top of the screen 402 as shown in FIG. 6B. Then, the side panels 110, 112 are pulled and positioned perpendicularly to the top 108 as shown in FIG. 6C. In this manner, the hood top 108 and the side panels 110, 112 are configured to shield the screen 402 from three sides and thus provide effective protection from glare and bright light. Finally, the side panels 110, 112 are secured to the back portion 102, which contacts the back of the screen, thereby making the hood top 108 flat and horizontal as illustrated in FIG. 6D.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “screen shade device”, “shade device”, “hood device”, “folding notebook computer hood” and “foldable screen shade device” are interchangeable and refer to the foldable screen shade device 100 of the present invention.

Notwithstanding the forgoing, the foldable screen shade device 100 of the present invention can be of any suitable size and configuration as is known in the art without affecting the overall concept of the invention, provided that it accomplishes the above-stated objectives. One of ordinary skill in the art will appreciate that the size, configuration, and material of the foldable screen shade device 100 as shown in the FIGS. are for illustrative purposes only, and that many other sizes and shapes of the foldable screen shade device 100 are well within the scope of the present disclosure. Although the dimensions of the foldable screen shade device 100 are important design parameters for user convenience, the foldable screen shade device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shield for a screen of an electronic device, the shield comprising:
a back panel having longitudinal side edges and transverse end edges;
a pair of side panels, wherein each of the pair of side panels is secured to one of the longitudinal side edges of the back panel; and
a top portion connected to the back panel along one of the transverse end edges, wherein the pair of the side panels are comprised of a dimension that is less than a dimension of the top portion.

2. The shield for a screen of an electronic device as recited in claim 1, wherein each of the pair of side panels is comprised of a curvilinear edge opposite the longitudinal edges of the back panel.

3. The shield for a screen of an electronic device as recited in claim 2, wherein the curvilinear edge allows for use of a keypad connected to the electronic device.

4. The shield for a screen of an electronic device as recited in claim 1, wherein the back panel includes a fastener.

5. The shield for a screen of an electronic device as recited in claim 4, wherein the back panel is provided with first and second fasteners.

6. The shield for a screen of an electronic device as recited in claim 5, wherein the first and second fasteners are elastic bands.

7. The shield for a screen of an electronic device as recited in claim 1, wherein the top portion includes an extendable flap.

8. A portable electronic device and a protective shield comprising:
a display connected to the portable electronic device and the display having a bezel;
a shield sized and configured to fit over the display and bezel of the portable electronic device;
the shield having a back panel, a top portion and side panels with the top portion connected to the back panel along a transverse fold line and the side panels connected to the back panel along longitudinal fold lines; and
the back panel having first and second fasteners for securing the shield to the bezel or display.

9. The portable electronic device and a protective shield as recited in claim 8, wherein the first and second fasteners are elastic bands.

10. The portable electronic device and a protective shield as recited in claim 9, wherein each of the side panels have a curved edge.

11. The portable electronic device and a protective shield as recited in claim 10, wherein the top portion includes an extendable flap.

12. The portable electronic device and a protective shield as recited in claim 11, wherein the shield is made from one of PVC, cardboard, plastic, paperboard, recycled plastic or other post-consumer waste materials, coated stock to make the screen impervious to rain or moisture, hard paper or combinations thereof.

13. The portable electronic device and a protective shield as recited in claim 12, wherein the side panels are constructed from a light filtering material.

14. The portable electronic device and a protective shield as recited in claim 13, wherein the shield is foldable on itself.

15. A foldable shade for an electronic device, the foldable shade comprising:
a back panel, top potion and first and second side panels, the back panel having longitudinal side edges and transverse end edges, with the top portion connected to the back panel along a transverse end edge and the side panels connected to the back panel along the longitudinal sides;
each of the side panels having a curvilinear edge and each of the side panels having at least one tab; and
the back panel having first and second fasteners and the back panel has a slot to receive each of the tabs of the side panels.

16. The foldable shade for an electronic device as recited in claim 15, wherein the top portion includes an extendable flap portion and the side panels are constructed from a light filtering material.
